(19) United States
(12) Patent Application Publication
(10) Pub. No.: US 2015/0357814 A1
(43) Pub. Date: Dec. 10, 2015

(54) Fault Current Limiter

(71) Applicant: GRIDON LTD, Givatayim (IL)

(72) Inventor: Vladimir Rozenshtein, Givatayim (IL)

(21) Appl. No.: 14/760,590

(22) PCT Filed: Jan. 9, 2014
(86) PCT No.: PCT/IL2014/050026

§ 371 Date: Jul. 13, 2015

(30) Foreign Application Priority Data
Jan. 11, 2013 (GB) 1300510.3

(51) Int. Cl. H02H 9/02; H01F 6/06

(52) U.S. Cl. CPC H02H 9/021; H02H 9/023; H01F 6/06

(57) ABSTRACT

A fault current limiter is provided for connection to a three phase AC supply. The fault current limiter comprises a first inductor for connection to a first phase of the AC supply; a second inductor for connection to a second phase of the AC supply; a third inductor for connection to a third phase of the AC supply. Each of the first, second and third inductors comprises a coil, and each of the coils of the first, second and third inductors is such that the self-reactance of each of the first, second and third inductors are substantially equal to a first reactance value. Furthermore, the coils of each of the first, second and third inductors are arranged such that the mutual reactance between each pair of inductors is substantially equal to a second reactance value, and the second reactance value is substantially equal to the first reactance value.

### DESCRIPTION

The present invention relates to a fault current limiter (FCL).

Faults in electrical power systems cannot be avoided. Fault currents flowing from the sources to a location of the fault lead to high dynamical and thermal stresses being imposed on equipment e.g. overhead lines, cables, transformers and switch gears.

Conventional circuit breaker technology does not provide a full solution to selectively interrupting currents associated with such faults. The growth in electrical energy generation and consumption and the increased interconnection between networks leads to increasing levels of fault current. In particular, the continuous growth of electrical energy generation has the consequence that networks reach or even exceed the limits with respect to their short circuit withstand capability. Therefore, there is a need for devices that are capable of limiting fault currents.

Short circuit currents are rising as transmission and distribution networks expand to address increasing energy demand and connectivity of power generation and intermittent energy sources. These may result in power disruptions, equipment damage and major outages, which have been estimated to cost billions of dollars per year. In order to restrict fault current impact, utility companies have traditionally needed to resort to network segmentation and installation of expensive and lossy protection gear, such as series reactors, capacitors, high rated circuit breakers and high impedance transformers. Such solutions come at the cost of overall reduction of energy efficiency and network stability.

The use of fault current limiters (FCL) allows equipment to remain in service even if the prospective fault current exceeds it rated peak and short-time withstand current. Thus, replacement of equipment (including circuit breakers) can be avoided or postponed to a later time.

A fault current limiter (FCL) can be provided in various forms. One type of fault current limiter involves a fully magnetised (saturated) iron core. Such fault current limiters typically have one or more AC coils wound around an iron core, with the iron core being maintained in a saturated state by a DC bias coil in normal operating conditions. The AC coils are connected to the grid, and in normal conditions the coil is kept saturated, providing a low insertion impedance.

In a fault condition (e.g. a short-circuit), a current surge will increase the current on the AC coil, causing desaturation of the iron core. As a result of this desaturation of the iron core, the impedance will rise, acting to limit the current trough the AC coil. Various arrangements of the saturable core and AC and DC coils are possible. An example of a prior art saturated core FCL is described in WO2007/029224.

Three-phase electric power is a common method of alternating-current electric power generation, transmission, and distribution. Conventional FCLs for three-phase AC supplies either use a single iron core on which AC coils for each of the three phases are wound, or use separate iron cores for each AC coil (one or two for each phase).

The present invention sets out to provide an FCL with improved performance compared to conventional arrangements. In particular, the present invention sets out to provide a three phase FCL that uses air core inductors.

According to an aspect of the invention, there is provided a fault current limiter for connection to a three phase AC supply, the fault current limiter comprising: a first inductor for connection to a first phase of the AC supply; a second inductor for connection to a second phase of the AC supply; a third inductor for connection to a third phase of the AC supply; wherein each of the first, second and third inductors comprises a coil; wherein each of the coils of the first, second and third inductors is such that the self-reactance of each of the first, second and third inductors are substantially equal to a first reactance value; wherein the coils of each of the first, second and third inductors are arranged such that the mutual reactance between each pair of inductors is substantially equal to a second reactance value, and wherein the second reactance value is substantially equal to the first reactance value.

In such arrangements, the FCL is associated with a very low insertion impedance for symmetrical loads in normal conditions. This is due to the balancing of the self and mutual reactances of the inductors. Furthermore, in single phase fault conditions, the inductor connected to the phase at fault will act to limit the fault, due to the fault conditions removing the balance of the self and mutual reactances of the inductors.

In some embodiments, the second reactance value is greater or equal to 85% of the first reactance value, optionally wherein the second reactance value is greater or equal to 90% of the first reactance value.

In some embodiments, the self-reactances of each of the first, second and third inductors are within 10% of each other, optionally wherein the self-reactances of each of the first, second and third inductors are within 5% of each other.

In some embodiments, the mutual reactances between each pair of inductors are within 10% of each other, wherein the mutual reactances of each of the first, second and third pair of inductors are within 10% of each other.

In some embodiments, a coil geometry of each of the coils of the first, second and third inductors is the same.

In some embodiments, a number of turns of each of the coils of the first, second and third inductors is the same.

In some embodiments, the first, second and third inductors have a different number of turns so as to compensate for a difference coil geometry of each of the coils of the first, second and third inductors is the same.

In some embodiments, each of the coils of the first, second and third inductors comprises a same material.

In some embodiments, the coil of each inductor is wound around a parallel axis.

In some embodiments, the coils of each inductor are wound around a common axis (e.g. on a common drum).

In some embodiments, the FCL further comprises a first input termination for the first inductor, a second input termination for the second inductor, and a third input termination for the third inductor, wherein the first, second and third input terminations are for connecting the first, second and third inductors in series with power carrying conductors connected to the three phase AC supply.

In some embodiments, the FCL further comprises a first output termination for the first inductor, a second output termination for the second inductor, and a third output termination for the third inductor, wherein the first, second and third output terminations are for connecting the first, second and third inductors in series with power carrying conductors connected to a load.

In some embodiments, the first, second and third inductors comprise superconductive material.

In some embodiments, a critical current to transition the superconductive material from a superconductive state to a resistive state is more than a current limited by the first, second and third inductors in the event of a single phase fault.

In some embodiments, the critical current to transition the superconductive material from the superconductive state to the resistive state is less than a current limited by the first, second and third inductors in the event of a three phase fault.

In some embodiments, the critical current to transition the superconductive material from the superconductive state to the resistive state is less than a current limited by the first, second and third inductors in the event of a two phase fault.

In other embodiments, the first, second and third inductors comprise non-superconductive material.

In some embodiments, the first, second and third inductors are comprised in a common three-core cable, wherein the common three-core cable is wound in a coil.

In some embodiments, the first, second and third inductors each inductor comprise a flat spiral coil, wherein the flat spiral coils of the first, second and third inductors are arranged in a stack of three flat spiral coils. In some embodiments, the three phase fault current limiter comprises a plurality of said stacks of three flat spiral coils. In some embodiments, a spacing of adjacent stack is equal to the spacing of each of the flat spiral coils within each stack.

In some embodiments, the coil of the second inductor is wound around the coil of the first inductor, and the coil of the third inductor is wound around the coil of the second inductor.

In some embodiments, the FCL further comprises at least one additional current limiter, each additional current limiter comprising a portion of HTS wire connected in series with a respective one of the first inductor, second inductor or third inductor; wherein the at least one additional current limiter is arranged to transition from a superconductive state to a resistive state in the event of a fault on the AC supply or load that it is connected to.

In some embodiments, the FCL further comprises a first additional current limiter connected in series with the first inductor, the first additional current limiter comprising a first circuit breaker and a first fuse connected in parallel; a second additional current limiter connected in series with the second inductor, the second additional current limiter comprising a second circuit breaker and a second fuse connected in parallel; a controller for controlling the operation of the first and second circuit breakers, and for monitoring current on the first, second and third inductors, wherein the controller is arranged to activate only the first circuit breaker in the event of a two phase fault and to activate both the first circuit breaker and the second circuit breaker in the event of a three phase fault.

In some embodiments, the FCL further comprises a first additional current limiter connected in series with the first inductor, the first additional current limiter comprising a first additional inductor and a first capacitor connected in series, the first capacitor arranged to compensate for the reactance of the first additional inductor in normal conditions, the first additional current limiter further comprising a first bypass electronic switch connected in parallel with the first capacitor; a second additional current limiter connected in series with the second inductor, the second additional current limiter comprising a second additional inductor and a second capacitor connected in series, the second capacitor arranged to compensate for the reactance of the second additional inductor in normal conditions, the second additional current limiter further comprising a second bypass electronic switch connected in parallel with the second capacitor; wherein in the event of a two phase fault, one of the first or second bypass electronic switch is arranged to close, so as to bypass the respective one of the first or second capacitors; wherein in the event of a three phase fault, both of the first and second bypass electronic switches are arranged to close, so as to bypass both of the first and second capacitors. The first and/or second bypass electronic switches may be thyristors.

In some embodiments, the air core inductors performed comprise three-core isolated cable wound around a drum. In some embodiments, the drum comprises aluminum or another metal with high heat conductivity.

In some embodiments, the inductors comprise multilayer coil. In some embodiments, one or more separators are provided between the cable layers. Such separators can be connected to the drum to enhance cable cooling.

In some embodiments, additional radiators connected can be connected to the drum for cable cooling.

In some embodiments, oil or other cooling liquid is provided to cool the inductors.

In some embodiments, three-core or three group multi-core cable is used for the inductors.

In some embodiments, at least one of the first, second and third inductors is an air core inductor. For example, all of the first, second and third inductors may be air core inductors. In other embodiments, one or two of the first, second and third inductors may be air core inductors.

In some embodiments, at least one of the first, second and third inductors may comprise a permeable (e.g. ferromagnetic) core located (or partially located) inside and/or around its coil. A high permeability core inserted inside the coils can efficiently increase self and mutual reactance.

Embodiments of the invention will now be described, by way of example, and with reference to the accompanying drawings in which:

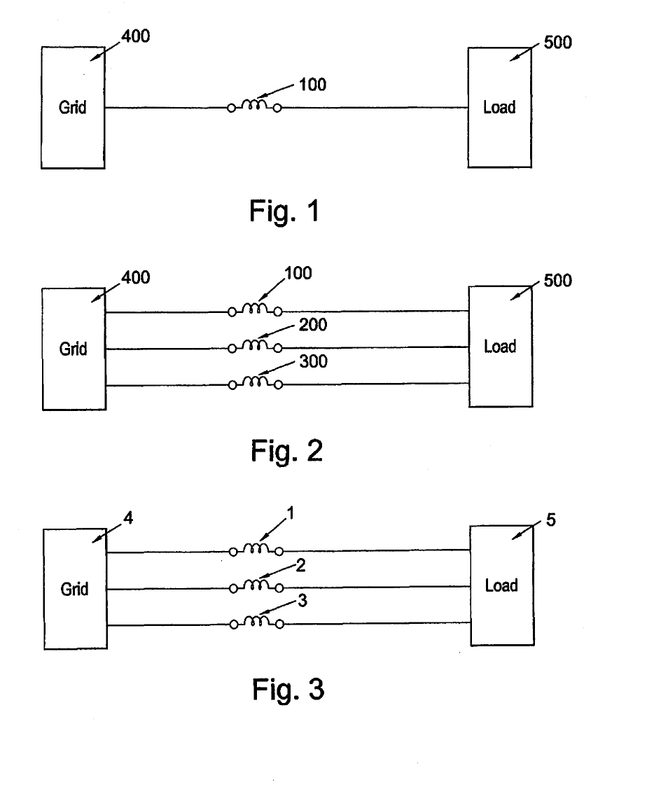

FIG. 1 shows a schematic diagram of an AC coil connected between an AC supply and a load;

FIG. 2 shows a schematic diagram of three AC coils connected between an AC supply and a load, with each of the AC coils connected to one phase of a three-phase supply;

FIG. 3 shows a schematic diagram of a three phase FCL according to an embodiment of the invention;

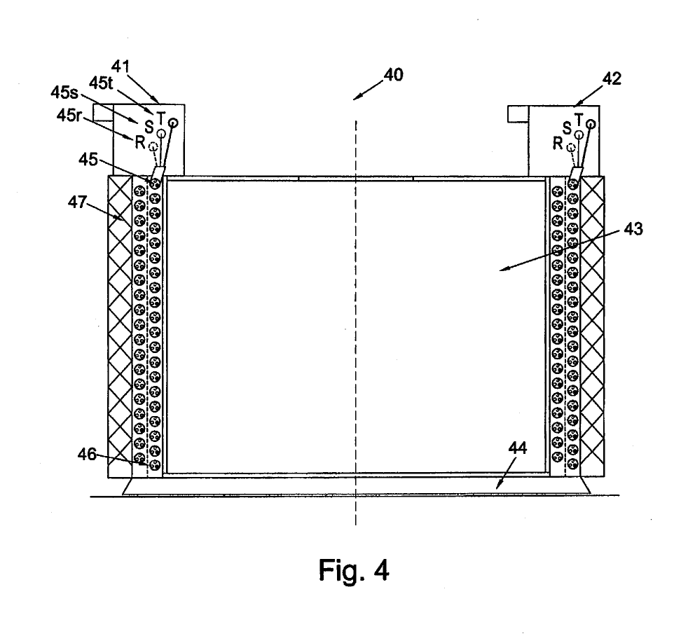

FIG. 4 shows an FCL according to an embodiment of the invention;

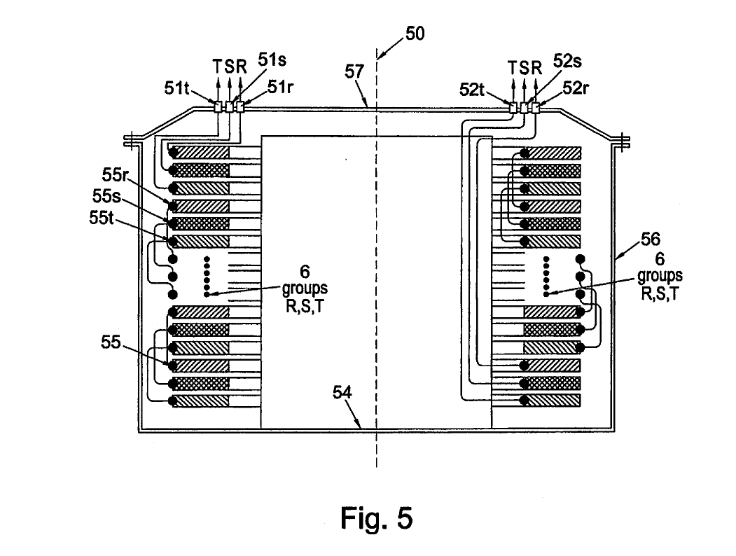

FIG. 5 shows an FCL according to an embodiment of the invention;

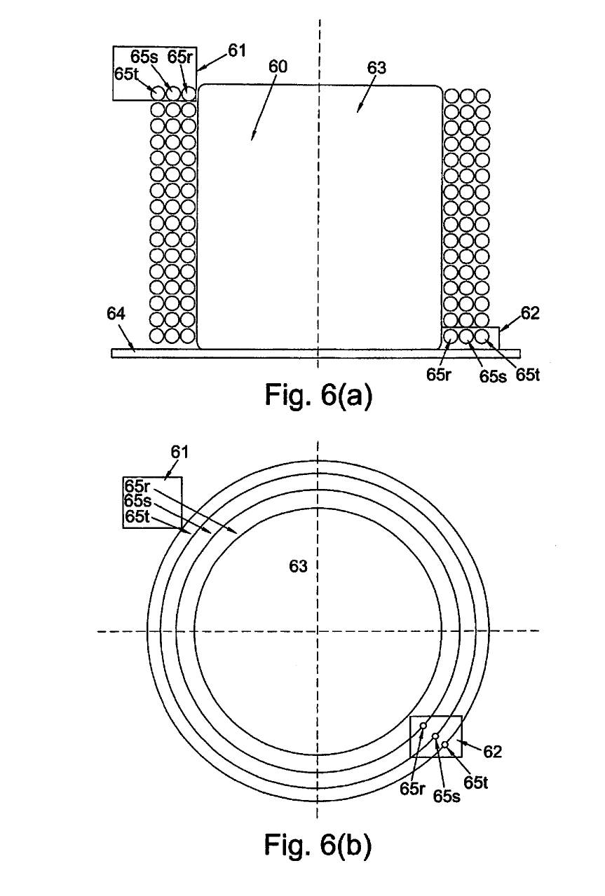

FIGS. 6a and 6b show an FCL according to an embodiment of the invention;

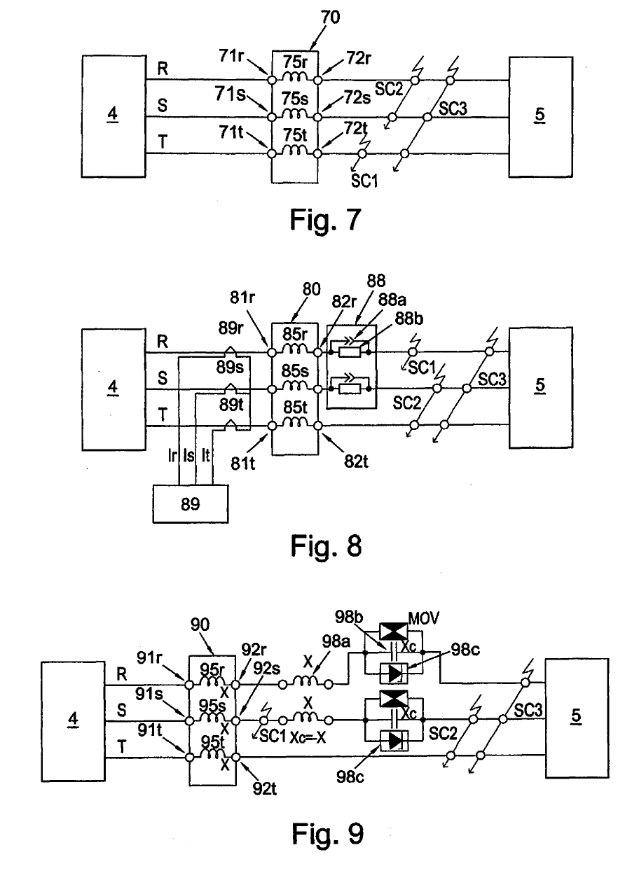

FIG. 7 shows an FCL according to an embodiment of the invention;

FIG. 8 shows an FCL according to an embodiment of the invention;

FIG. 9 shows an FCL according to an embodiment of the invention;

It will be appreciated that the term “air core inductor” describes an inductor that does not use a magnetic core made of a ferromagnetic material. The term typically refers to coils wound on plastic, ceramic, aluminium, or other nonmagnetic forms, as well as those that have only air inside the windings.

FIG. 1 shows a schematic diagram of an AC coil 100, connected between an AC supply 400 (labelled “Grid”) and a load 500. The AC coil 100 is wound around a plastic drum (not shown). Hence, the AC coil 100 can be considered to be an air core inductor.

It will be appreciated that the AC current running through the AC coil 100 creates a magnetic field in and around the coil that increases and decreases as the current changes. This changing magnetic field causes a voltage to be induced in the AC coil 100, with this voltage opposing the changing magnetic field, with the amount of voltage inducted being dependent of the self-reactance of the coil. It will be appreciated that the self-reactance of the AC coil causes a voltage drop of ΔV=IX (where I is the current on the coil, and X is the self-reactance). Hence, the presence of the AC coil 100 (as opposed to the same length of uncoiled wire) is associated with an insertion impedance resulting from the self-reactance of the coil.

FIG. 2 shows a schematic diagram of three AC coils 100, 200 and 300, each connected to one phase of a three-phase supply 400, labelled as “Grid”, and to a load 500. Coil 100 is connected to the R phase, coil 200 is connected to the S phase, and coil 300 is connected to the T phase.

In this arrangement, the AC coils 100, 200 and 300 have the same coil geometry (i.e. the same configuration, length, and number of turns and are wound around a plastic drum (not shown). Hence, each of the AC coils 100, 200 and 300 can be considered to be air core inductors.

If each of the AC coils 100, 200, 300 has the same coil geometry, then each coil will have the same self-reactance value. Hence, the self-reactance value XR of coil 1 (R) will be equal to the self-reactance value XS of coil 200 (S), and equal to the self-reactance value XT of coil 300 (T). Hence, XR=XS=XT=X.

If the distance between the AC coils 100, 200 and 300 is relatively large, then there would not be significant inductive coupling between the AC coils 100, 200 and 300 and the mutual reactance between the AC coils 100, 200 and 300 would be low. In this case, the voltage drops for each AC coil 100, 200, 300 could be expressed as ΔVR=ΔVS=ΔVT=IX (where I is the current on each coil, assuming a symmetrical load for each phase), and any effects from the mutual reactances between the coils could be ignored.

However, if the AC coils are arranged closer together, then there will be inductive coupling between the coils. In particular, embodiments of the invention relate to arrangements in which there is significant inductive coupling between the coils, such that the mutual reactances for each coil pair are close to equal to each other, and close to equal to the self-reactance values of each coil (which are themselves equal).

FIG. 3 shows a schematic diagram of a three phase FCL according to an embodiment of the invention that shows three AC coils 1, 2 and 3, each connected to one phase of a three-phase supply 4, labelled as “Grid”, and to a load 5. Coil 1 is connected to the R phase, coil 2 is connected to the S phase, and coil 3 is connected to the T phase. In this arrangement, the AC coils 1, 2 and 3 have the same coil geometry (i.e. the same configuration, length, and number of turns) and are wound around a plastic drum (not shown). Hence, each of the AC coils 1, 2 and 3 can be considered to be an air core inductor.

As the AC coils 1, 2, 3 have the same coil geometries, then they will have the same self-reactance values and XR=XS=XT=X.

In addition, in this embodiment, the coils 1, 2 and 3 are arranged so that the mutual reactances between each pair of coils are equal to each other. In other words, the coils 1, 2 and 3 are arranged so that XRS=XRT=XST. It will be appreciated that it is possible to arrange the coils 1, 2 and 3 so the mutual reactances between each pair of coils are equal to each other in a number of ways, for example by spacing the three coils an equal distance apart from each other in a suitable manner. It is noted that in FIG. 3 the coils 1, 2 and 3 are shown arranged in a line. However, this is merely for ease of illustration.

The coils 1, 2 and 3 are also arranged so that the mutual reactances between each coil pair are close to equal to the self-reactance values of each coil. In other words, the coils 1, 2 and 3 are arranged so that XRS=XRT=XST=αX (where XR=XS=XT=X). It will be appreciated that the mutual reactances between each coil pair cannot be exactly equal to the self-reactance values of each coil (i.e. α must be less than 1). However, by inductively coupling the coils 1, 2 and 3 as much as possible (e.g. by arranging each coil 1, 2 and 3 as close together as possible), it is possible to achieve values of a greater than 0.85. In particular, in some embodiments of the invention a can be from 0.85 to 0.97, or 0.90 to 0.97.

As a result of the above, the three phase FCL according to the embodiment of the invention schematically shown in FIG. 3 satisfies the following conditions:

XR=XS=XT=X [Equation 1]

XRS=XRT=XST=αX [Equation 2]

It will be appreciated that for a symmetrical load, the current on each phase will be equal in nominal conditions. Considering the currents in vector form, then the currents on each coil 1, 2 and 3 will be ÎR, ÎS, and ÎT respectively. For the symmetrical load it will be the case that the sum of the vector currents will be zero, i.e. that ÎR+ÎS+ÎT=0.

If a=ej(2π/3) wherein j is the square root of −1 and I is the vector on the real axis with magnitude of root mean square (RMS) value of ÎR, then it will be appreciated that ÎR=I, ÎS=Ia2, ÎT=Ia. As ÎR+ÎS+ÎT=0, it is clear that 1+a2+a=0.

Unlike the case for the arrangement of FIG. 2 (where there is very little inductive coupling between the AC coils), the mutual reactances between each of pairs of the coils 1, 2 and 3 have a significant effect on the voltage drop on each coil 1, 2 and 3.

The change in voltage experienced by each coil will be the sum of the change in voltage caused by self-reactance of the coil (e.g. the R coil), the change in voltage caused by the mutual reactance between that coil and one of the other two coils (e.g. between the R and S coils), and the change in voltage caused by the mutual reactance between that coil and the other of the two coils (e.g. between the R and T coils).

The change in voltage caused by the self-reactance of coil 1 will be equal to ÎRXR. As noted above, XR=X, and it will be appreciated that the change in voltage caused by the self-reactance of coil 1 can be expressed as jIX.

The voltage drop caused by the mutual reactance between coils 1 and 2 will be equal to the current on the S phase (i.e. on coil 2) multiplied by XRS. As shown above, the current on the S phase coil equals ÎS=Ia2. Furthermore, as XRS=αX, it will be appreciated that the change in voltage caused on coil 1 as a result of the current on coil 2 will be equal to jIa2αX.

Likewise, the change in voltage caused by the mutual reactance between coils 1 and 3 will be equal to the current on the T phase (i.e. on coil 3), which equals ÎT=Ia, multiplied by XRT. Hence, as XRT=αX, it will be appreciated that the change in voltage caused on coil 1 as a result of the current on coil 3 will be equal to jIaαX.

As a result, the total voltage drop experienced by coil 1 (R phase) can be expressed as:

ΔVR=jIX+jIa2αX +jIaαX

It will be appreciated that all coils will have resistive part of impedance as well. However, this component can be ignored due to the fact that this will be very much less than the reactive part. It follows from this that:

ΔVR=jIX(1+a2α+aα)

The term jIX(1+a2α+aα) can be written as jIX(1−α+α+a2α+aα). As shown above, 1+a2+a=0. Hence it follows that:

ΔVR=jIX(1−α)

For the S phase, the change in voltage caused by the self-reactance of coil 2 will be equal to ÎSXS. As noted above, XS=X and ÎS=Ia2, and it will be appreciated that the change in voltage caused by the self-reactance of coil 2 can be expressed as jIa2X.

The change in voltage on coil 2 as a result of the current on coil 1 will be equal to the current on the R phase (i.e. on coil 1) multiplied by XRS. As shown above, the current on the R phase coil equals ÎR=I. Furthermore, as XRS=αX, it will be appreciated that the change in voltage on coil 2 as a result of the current on coil 1 will be equal to jIαX.

The change in voltage on coil 2 as a result of the current on coil 3 will be equal to the current on the T phase (i.e. on coil 3) multiplied by XST. As shown above, the current on the T phase coil equals ÎT=Ia. Furthermore, as XST=αX, it will be appreciated that the change in voltage on coil 2 as a result of the current on coil 3 will be equal to jIaαX.

As a result, the total voltage drop experienced by coil 2 (S phase) can be expressed as:

ΔVS=jIa2X+jIαX+jIaαX

It follows from this that:

ΔVS=jIX(a2+α+aα)

The term jIX(a2+α+aα) can be written as jIX(α+αa 2+αa−αa 2+a2). As shown above, 1+a2+a=0. Hence it follows that:

ΔVS=jIX(1−α)a2

For the T phase, it will be appreciated that the change in voltage caused by the self-reactance of coil 3 will be jIaX. The voltage drop on coil 3 caused by the current on coil 1 will be jIαX, and the voltage drop on coil 3 caused by the current on coil 2 will be jIa2αX.

As a result, the total voltage drop experienced by coil 3 (T phase) can be expressed as:

ΔVT=jIaX+jIαX+jIaα2X

It follows from this that:

ΔVT=jIX(1−α)a

Therefore, it has been demonstrated that the voltage drop associated with each phase coil is proportional to (1−α). Hence, the insertion impedance for a symmetrical load is proportional to (1−α).

It will be appreciated that the positive sequence impedance of the proposed FCL equals X(1−α), but the zero sequence impedance is X(1+2α).

As described above, it is desirable that α is close as possible to 1 in embodiments of the invention. It is therefore the case that for values of α close to 1 (e.g. greater than 0.90), the insertion impedance for a symmetrical load for each phase coil is close to zero (as 1−α≈0).

As a result, an FCL with three air core inductors as shown in FIG. 3 is associated with very low insertion impedance for symmetrical loads in normal conditions.

By far the most common fault in a three phase power system is a single phase fault.

In single phase fault conditions, the fault current on one of the three phases will dwarf the current on the other of the two phases. As a result, in order to model the behavior of the FCL with air core inductors as shown in FIG. 3 in single phase fault conditions, it can be assumed that the fault current IF on the phase coil experiencing the fault is high with the currents on the other phase coils being negligible in comparison.

As a result, if the fault current is on coil 1 (R phase), then the total change in voltage is dominated by the self-reactive component, with the mutual reactive components being negligible in comparison. This is because the change in voltage caused by the mutual reactance between coils 1 and 2 depends on the current on coil 2, and the change in voltage caused by the mutual reactance between coils 1 and 3 depends on the current on coil 3. Therefore, if the fault current IF on coil 1 is much greater than the currents on coils 2 and 3, then the currents on coils 2 and 3 can be ignored and total voltage drop in single phase fault conditions can be approximated to be:

ΔVRfault=jIFX

It is clear that the voltage drop in fault conditions ΔVRfault will be substantially higher that the near zero voltage drop ΔVR in normal conditions.

Hence, an FCL with air core inductors as shown in FIG. 3 is associated with very low insertion impedance for symmetrical loads in normal conditions, while strongly acting to limit single phase faults.

As discussed, in embodiments of the invention, the three phase coils are arranged so that they have equal self-reactance values, and with mutual reactances of each coil pair being close to equal to each other and close to equal to the self-reactance values of each coil.

In order to achieve the property of the three phase coils having approximately equal self-reactance values, it possible to arrange the coils with equal or close to equal coil geometries. For example, two coils with the same configuration, length, and number of turns and windings will have close to identical self-reactance values. Furthermore, if the variation between the coil geometries of coils is small, then the differences between the self-reactance values of each coil will be small.

Furthermore, it will be appreciated that it is possible to perform winding for a coil with more diameter and less number of turns which has same self and mutual reactance as another coil winding which has less diameter and more number of turns. It is also possible to arrange coils with rectangular and circular forms to achieve the desired effect of the three phase coils having approximately equal self-reactance values.

Hence, it will be appreciated that it is possible to have the three phase coils having approximately equal self-reactance values without them having the same coil geometries.

In order to achieve the property that the mutual reactances between each coil pair being roughly equal to each other in a number of ways, for example by spacing the three coils roughly an equal distance apart from each other.

Furthermore, it will be appreciated that, due to fact that the induced field is concentrated inside an air coil, the mutual reactance of each pair of coils placed apart from each other will usually will very small. One way of providing the property that the mutual reactances between each coil pair being roughly equal is using a three core cable (in flat or another form of isolated cable) for wounding all three phase coils. In this case all wires will be close each to another and as result mutual reactance will close to self-reactance.

Another way of achieving this property is to use, for each phase group, flat (pancake form) coils placed as close to each other as possible according with insulation needs and arranged or stacked as R-S-T-R-S-T. Such an arrangement benefits from using a relatively large number of coils in each phase group (e.g. 10).

A further way of achieving this property is to use co-axial placement of coils with a minimum distance between the coils. In order to achieve the property that the mutual reactances between each coil pair are close to equal to the self-reactance values of each coil, it is desirable to maximise the inductive coupling between each pair of coils. This can be done by arranging each coil as close as possible to each other coil.

In the arrangement of FIG. 3, the inductors 1, 2 and 3 are arranged such that their self-reactances are substantially equal to a first reactance value, and that the mutual reactances between each pair of inductors 1, 2 and 3 is substantially equal to a second reactance value, with the second reactance value being substantially equal to the first reactance value.

As discussed, this has been expressed as XR=XS=XT=X and XRS=XRT=XST=αX However, it will be appreciated that these equations can be generalized to XR≈XS≈XT=X and XRS≈XRT≈XST=αX, as in certain practical embodiments the conditions of exact equivalence of the self and mutual reactances will not be achieved.

In other words, Equations 1 and 2 can be expressed as:

XR=γ1XS=γ2XT=X [Equation 3]

XRS=β1XRT=β2XST=αX [Equation 4]

In Equation 3, it is desirable for the values of γ1 and γ2 to be as close to 1 as possible. It has been found that beneficial results are achieved when 0.9<γ1, γ2<1.1.

Regarding Equation 4, this leads to XRS=αX, XST=(α/β2)X, XRT=(α/β1)X. It is desirable to provide β1, β2 such that α/β2<1/γ1, and α/β2<1/γ2, and for α/β1<1 and α/β1<1/γ2.

It has been found that beneficial results are achieved when β1 and β2 are in the range 0.9-1.1, with the additional conditions that α/β2<1/γ2and α/β2<1/γ1, and α/β1<1 and α/β1<1/γ2. These additional conditions are based on the fact that the mutual inductance is always less than the self inductances.

In general, it is desirable that the differences in the self and mutual reactances vary not more than 10%, with a variation of less than 5% being beneficial.

The arrangement of FIG. 3 could use either superconductive or non-superconductive material for the coils 1, 2 and 3.

It will be appreciated that if the coils are formed from HTS (high temperature superconductive) wire, then suitable cooling means (not shown) would be required.

It will be appreciated that HTS wire may be superconducting up to a predetermined current. In some embodiments of the invention in which HTS wire is used for the coils 1, 2 and 3, the FCL can be designed so that the normal operating and single phase fault limited current of the FCL is well below the predetermined superconducting phase-transition current. This is discussed in more detail later.

As described above, FIG. 3 shows a schematic diagram of a generalized embodiment of the invention. The arrangement of the coils 1, 2 and 3 is shown schematically, and it will be appreciated that many possible variations of coil geometry, arrangement and materials are possible. A number of more specific embodiments of the invention will now be discussed.

FIG. 4 shows an FCL 40 according to an embodiment of the invention.

The FCL 40 comprises a drum 43 on a base 44. In this embodiment, the drum 43 is made from aluminium. In other embodiments, it could be made from any suitable material with good thermal conductivity. In this embodiment, the base 44 is made from concrete. In other embodiments, it could be made from any suitable material such as metal or other non-flammable material.

In this embodiment, the inductors for each of the three phases of the AC supply (not shown) are provided in a single three-core cable 45. The three-core cable 45 comprises a first inductor 45r for the R phase, a second inductor 45s for the S phase, and third inductor 45t for the T phase, with all inductors being suitably insulated from each other. In this embodiment, the three-core cable 45 is standard XLPE cable.

In this embodiment, the XLPE cable comprises three core unarmoured HT XLPE cables with a voltage grade of 6/10(12) kV, type 2XSEYT and applicable specification: IEC 60502-2. Each core of such cables comprises (from inner to outer): a stranded copper conductor, an extruded semiconducting conductor screen, XLPE insulation, an extruded semiconducting insulation screen, and a metallic screen of copper. PVC filler is arranged between each core, with an extruded PVC inner covering and an extruded PVC oversheath around the bundle of three cores.

The FCL 40 is provided with an input connection box 41 and an output connection box 42, with the input and output connection boxes 41, 42 being located at the opposite end of the drum to the base (i.e. at the top end in this embodiment). The three-core cable 45 passes from the input connection box 41 to the output connection box 42, connecting the input and output connection boxes 41, 42. The input connection box 41 is connected to the three phase AC supply (not shown) via power carrying conductors (not shown). The output connection box 42 is connected to a load (not shown) via power carrying conductors (not shown). Hence, the three-core cable 45 connects the three phase AC supply to the load.

The three-core cable 45 is wound as a coil around the drum 43. In this embodiment, the winding starts at the top of the drum 43 from the region of the input connection box 41, and passes to the bottom of the drum (i.e. the region of the base 44). In this embodiment, the three-core cable 45 is then wound back towards the top of the drum, ending back at the top of the drum in the region of the output connection box 42. As a result, the three-core cable 45 is wound around the drum in a downward spiral, and then around the drum again in an upward spiral. The turns of the upwards spiral are located around the turns of the downwards spiral

A separator 46 is provided between the windings of the three-core cable 45 on the downward spiral and the upward spiral. In this embodiment, the separator 46 is formed out of aluminium sheet, and aids in heat transfer. In some embodiments, one or more separators are provided between the cable layers. Such separators can be connected to the drum to enhance cable cooling.

In this embodiment, radiators 47 are provided around the upward spiral of the three-core cable 45 to further aid in heat transfer. In this embodiment, the radiators 47 are made from aluminium. In other embodiments, it could be made from any suitable material with good thermal conductivity.

It will be appreciated that the arrangement described above is such that each inductor 45r, 45s and 45t forms a coil around the drum 43. In this embodiment, the configuration of the three-core cable 45 means that each of the inductors 45r, 45s and 45t have substantially the same coil geometries. This is because they have the same number of turns, and are the same length. They are also made from the same materials, and have the same coil diameter. As a result, the self reactances of each of the inductors 45r, 45s and 45t will be substantially equal to each other.

Furthermore, each of the inductors 45r, 45s and 45t are arranged very close together within the three-core cable 45, and there will be strong inductive coupling between each pair of the inductors 45r, 45s and 45t. The winding axis of the three-core cable is arranged vertically, and thus the winding axis of the each of the inductors 45r, 45s and 45t is also arranged vertically. The coils formed by each of the inductors 45r, 45s and 45t will be arranged symmetrically with respect to each other, with the same separation between each coil. Hence, the mutual reactances between each pair of the inductors 45r, 45s and 45t will be close to equal and close to the self reactances of each of the inductors 45r, 45s and 45t.

As a result, the arrangement shown in FIG. 4 will have the properties shown in Equations 1 and 2 above. In other words, an FCL with air core inductors as shown in FIG. 4 is associated with very low insertion impedance for symmetrical loads in normal conditions, while strongly acting to limit single phase faults.

In this embodiment, the three-core cable 45 has 40 turns, and the drum 43 has a height of 1.7 m and an average diameter of 1.95 m.

This embodiment provides what can be considered to be an FCL with specification data as provided below:
Rated Voltage 12 kV,
Rated current 525 A,
Impedance for symmetrical load ˜0.1-0.12 Ω;
Impedance for single phase fault current ˜0.7-0.75 Ω

In other embodiments alternative forms of three-core cable for the three inductors could be used, for example using different materials for the cable and/or different form of cables and/or different means for cable cooling.

In other embodiments that use a three-core cable for the three inductors, the three-core cable can be arranged in different ways. In FIG. 4, the three-core cable is wound twice (downwards then upwards) around the drum 43. However, the three-core cable could be wound around the drum a different number of times (e.g. three). Furthermore, the three-core cable could be wound only around a part of the length of the drum 43. Furthermore, the three-core cable could be wound around a different shape drum or other around another suitable support.

In other embodiments, the three-core cable could be wound around a drum or support during manufacture, and then the drum or support could be removed. Thus, the three-core cable in the completed FCL would have no drum.

In the embodiment of FIG. 4 there is an input connection box 41 and an output connection box 42. In other embodiments, the ends of the three-core cable may be connected to the AC supply/load in other ways. FIG. 4 shows the input connection box 41 and an output connection box 42 at the top of the drum. In other embodiments, the input connection box 41 and an output connection box 42 can be located at different regions of the drum 43. Furthermore, the input connection box 41 and an output connection box 42 could be located at different ends of the drum.

In the embodiment of FIG. 4 there is a separator 46 between the upward and downward winding of the three-core cable. In other embodiments, such a separator 46 is not required. Furthermore, in the embodiment of FIG. 4 there is a radiator 47 located around the outer of the three-core cable. In other embodiments, such a radiator 47 is not required.

In the embodiment of FIG. 4 the drum is arranged on a base 44, with the cylinder axis of the drum arranged vertically (with the winding axis of the three-core cable arranged vertically). It will, however, be appreciated that the drum could be supported in other ways. In particular, the drum could be arranged so that its cylinder axis was arranged horizontally. Furthermore, the three-core cable could be wound without a drum with the winding axis of the three-core cable arranged horizontally (or any other orientation).

As discussed above, the embodiment shown in FIG. 4 is associated with very low insertion impedance for symmetrical loads in normal conditions, while strongly acting to limit single phase faults. If it is desired to limit two or three phase faults, then additional current limiters can be used, as discussed in more detail below.

In this embodiment, the three-core cable is XLPE cable. However, in other embodiments different types of three-core cable could be used. For example, flat three-core cable with appropriate insulation could be used. Furthermore, any type of three-core cable without screen as used for transformer manufacturing could be used.

An FCL according to this embodiment is suitable for a range of applications. One example, is for a double-fed large wind turbine. In a double-fed wind turbine mentioned a phase to ground fault in such generators may be only limited in practical terms by a land placed device (height of support for these machines is greater than 100 m).

In other arrangements, any three-core or multi-core cable divided in 3 groups (e.g. 27 cores=3×9, 36 cores=3×12) could be used, with such cable placed in vessel with oil or another liquid for cooling of the cable.

FIG. 5 shows an FCL 50 according to another embodiment of the invention.

FIG. 5 shows a side view of the FCL 50. In this embodiment, there is a gas or liquid filled vessel 56 with a cover 57. In this embodiment, the gas is helium. However, in other embodiments, other fluids e.g. hydrogen or liquid nitrogen could be used. In this embodiment, the cover 57 is made from stainless steel. In other embodiments, it could be made from any suitable material that is suitably hard and non-magnetic, such as fibreglass.

Connected to the cover 57 are three input isolators 51r, 51s, and 51t, with each input isolator 51r, 51s, and 51t being connected to each phase of a three phase AC supply (not shown) via power carrying conductors (not shown). Also provided are three output isolators 52r, 52s, and 52t, with each output isolator 52r, 52s, and 52t being connected to a load (not shown) via power carrying conductors (not shown).

Within the vessel 56 there are three inductors 55r, 55s, and 55t that are respectively connected between the input isolators 51r, 51s, and 51t and output isolators 52r, 52s, and 52t.

The three inductors 55r, 55s, and 55t are arranged as a number of series connected of flat spiral coils in pancake form. In this embodiment, each pancake has an internal turn made from copper, which provides an output and with connection buses support for pancakes. The pancakes are supported by a bottom 54 of the vessel 56.

In this embodiment, each of the inductors 55r, 55s, and 55t is formed from HTS wire, and a suitable cooling device (not shown) is provided. The gas or liquid in the vessel 56 is kept at around a temperature of 20-70 K.

The inductors 55r, 55s, and 55t are wound so that there is a flat spiral coil for a first phase (e.g. R), a spiral coil for the second phase (e.g. S), and a flat spiral coil for the third phase (e.g. T) in that order. These three flat spiral coils (one for each phase) form a stack 55. The FCL 50 is arranged with a number of such stacks 55.

Considering the inductor 55r for the R phase, it forms a first flat spiral coil for the R phase around the last copper turn which is connected to terminator 51r, with the input end of the first flat spiral coil (the outer end) connected to the input isolator 51r. The output end of the first flat spiral coil (the inner end) is connected to the input end (inner end) of a second flat spiral coil for the R phase, with the second flat spiral coil for the R phase being in the next R, S, T stack 55. The inductors for the S and T phases are arranged in the same way.

Hence, the FCL 50 comprises a number of stacks of flat spiral coils, with each stack comprising a flat spiral coil for each of the three phases.

Although not shown in FIG. 5, in this embodiment 10 stacks of flat spiral coils are provided, with each stack comprising a flat spiral coil for each of the three phases, giving a total of 30 flat spiral coils. In this embodiment, the clearances between each flat spiral coil (e.g. between an R phase inductor 55r and an S phase inductor 55s are designed to be minimal as possible for providing need isolation between different phases e.g. 0.5 mm for voltage 400V in helium.

As a result of the above, the inductors 55r, 55s, and 55t can be considered to have substantially the same coil geometries. This is because they have the same number and configuration of flat spiral coils in pancake form with same number of turn for each pancake. They are also made from the same material. As a result, the self reactances of each of inductors 55r, 55s, and 55t will be substantially equal.

Furthermore, as a result of the small distance between each flat spiral coil (as a result of the small clearance between them), there will be a large amount of coupling between the inductors 55r, 55s, and 55t. Within a stack, while the distance between the R phase inductor 55r and the S phase inductor 55s will be the same as the distance between the S phase inductor 55s and the T phase inductor 55t, there is a marginally greater distance between the R phase inductor 55r and the T phase inductor 55t. However, due to large number of the stacks and fact that distance between 55t in pervious stack and 55r in next stack will small, the effect of this difference in distance is not significant and the mutual reactances between each pair of the inductors 55r, 55s, and 55t (included all 10 stacks) will be substantially equal to each other and substantially equal to the self reactances of each of the inductors 55r, 55s, and 55t.

In this embodiment, each of the 30 pancakes have the same configuration and are placed on same distance (around 0.5 mm) each from other, with the height of each pancake being around 5 mm). The stacks will be arranged as close as possible together, so that the distance between one RST stack is the same as the distance between two adjacent pancakes within a stack.

Consider the distance between each two pancakes to be q, the height of each pancake to be h, and consider that h+q=Q. Then, for self inductance of phase R we will get complex function as 10 times self-inductance of each pancake and 9 times of mutual inductance two pancakes on distance (3 Q), 8 times-on distance (6 Q), 7 times on (9 Q) etc.

Furthermore, the mutual reactance between 55r and 55t will be less (in one stack) than between 55r and 55s or 55s and 55t. However, the next stack R,S,T will have the first coil of phase R closest to previous of phase T. It will be appreciated there will be a mutual reactance between the pancakes in adjacent stacks. Thus, with increasing of number of stacks we can get mutual reactance for each phase pairs close one to another.

In this embodiment, the equation for the mutual reactances can be considered to be X_{RS}=X_{ST}=β₁X_{RT}=αX, where β₁>1. Due to fact that R and T phases are outer in any stack, X_{RT} will be slightly less than X_{RS}=X_{ST} thus β₁>1. In some embodiments, β₁ is around 1.05.

As a result, the arrangement shown in FIG. 5 will have the properties shown in Equations 1 and 2 above.

In this embodiment, the design is such that the minimal current through superconductive wires of the inductors 55r, 55s, and 55t which causes phase change from superconductive state to resistive state, is slightly higher than the current limited by just the inductances of the coils during single-phase fault. This is discussed in more detail below in relation to FIG. 7.

In this embodiment, the diameter of the vessel is 225 mm, and the height is 200 mm. The inner diameter of the vessel 56 is 120 mm.

In this embodiment, the arrangement of the inductors 55r, 55s, and 55t provide self-inductance of all phase group coils as ˜15.9 mH and mutual inductance as ˜14.3 mH and thus for three-phase 50 Hz symmetrical load ˜15 A will give a voltage drop of ˜7.5V or 3.3%.

In case of single phase short-circuit the fault current will be limited to ˜45 A by the reactance of the FCL without phase change into resistive state of the superconductive wires. In case of two or three phase short-circuit the fault current in first stage will more than 50 A (critical current for standard HTS wire) and HTS wires will phase change into resistive state and limit this fault current up to 35-45 A.

This embodiment provides an FCL with specification data as provided below:
Rated Voltage 3×400V,
Rated current 15 A,
Impedance for symmetrical load ˜0.5Ω
Impedance for single phase fault current ˜5Ω
Impedance for three phase or two phase fault current ˜6Ω (after phase change of superconductive wires into resistive state)

In other embodiments, pancakes made from 3-phase flat HTS wire could be used. In a similar way to what is described above, a number of such pancakes may compensate for a difference in mutual inductance between RT and RS, ST phases.

In other embodiments, a high permeability core can be inserted in the internal cylinder of the vessel 56. Thus the permeable (e.g. ferromagnetic) core would be outside of the vessel 56 and not subjected to its low temperature. Such a permeable core would be inside the coils of the inductors 55r, 55s, and 55t. By placing a permeable (e.g. ferromagnetic) core inside (or partially inside) the coil, the self and mutual reactance of the inductors can be increased.

FIGS. 6a and 6b show an FCL 60 according to another embodiment of the invention.

FIG. 6a shows a side view of the FCL 60. The FCL 60 comprises a drum 63 on a base 64, an input connection box 61 at the top end of the drum and an output connection box 62 at a bottom end of the drum 63 (the end near the base 64). Inductors 65r, 65s, 65t for each of the three phases of the AC supply (not shown) are connected between the input connection box 61 and the output connection box 62 via power carrying conductors (not shown). FIG. 6b shows a cross sectional view of the FCL 60 through its drum 63.

The inductor 65rfor the R phase is wound around the drum 63 from the input connection box 61 to the output connection box 62, forming a coil around the drum. The inductor 65s for the S phase is wound around the coil formed by the inductor 65r for the R phase from the input connection box 61 to the output connection box 62. Likewise, the inductor 65t for the T phase is wound around the coil formed by the inductor 65s for the S phase from the input connection box 61 to the output connection box 62.

As a result, the coils formed by the inductors 65r, 65s, 65t resemble three concentric cylinders. In this embodiment, a separator 66a is provided between the coil of the inductor 65r and the coil of the inductor 65s, and a separator 66b is provided between the coil of the inductor 65s and the coil of the inductor 65t. However, in other embodiments, the inductors could be insulated from each other in other ways.

In this embodiment, the inductors 65r, 65s, 65t for each of the three phases of the AC supply (not shown) are wound around the drum 63 in the form of concentric cylinders around the drum. 63. The inductors 65r, 65s, 65t in this embodiment are wound from the same non-superconductive material. In this embodiment, the dimensions of the FCL are the same as the FCL of FIG. 4.

As a result of the above, the inductors 65r, 65s, 65t can be considered to have substantially the same coil geometries. This is because they have the same number of turns and have close to equal coil diameters. They are also made from the same material. As a result, the self reactances of each of inductors 65r, 65s, and 65t will be substantially equal.

It is noted that the coil diameter of the inductor 65t will be slightly greater than the coil diameter of the inductor 65s, which will itself be slightly greater than the coil diameter of the inductor 65r. However, while this change in coil diameter will mean that self reactances of each of inductors 65r, 65s, and 65t will not be exactly equal, the difference will not be significant.

In such arrangements, with a single cable for each inductor it is possible to compensate for the increase in diameter of the outer inductor using fewer numbers of turns.

For example, in this embodiment, the diameter of the inductor 65t may be around 4% more than for the inductor 65r. In this case, it is possible to use the same number of turns (e.g. 100), and the difference in the self reactances of the inductors 65r and 65t will not be significant.

However, for more a accurate approach in order to ensure same self inductance for the inductors 65r and 65t inductors, it is possible to use, for example, 98 turns for the inductor 65t vs 100 turns for the inductor 65r inductor. It will be appreciated that the inductance of an air coil inductor is proportional to number of turns squared.

Furthermore, as a result of the small distance between each inductor coil, there will be a large amount of coupling between the inductors 65r, 65s, and 65t. Hence, the mutual reactances between each pair of the inductors 65r, 65s, and 65t will be substantially equal to each other and substantially equal to the self reactances of each of the inductors 65r, 65s, and 65t.

In other embodiments, a high permeability core can be inserted inside the coils of the inductors 65r, 65s, and 65t. By placing a permeable (e.g. ferromagnetic) core inside the coil, the self and mutual reactance of the inductors can be increased.

FIG. 7 shows an FCL 70 according to another embodiment of the invention. In this embodiment, the FCL 70 is shown schematically, and comprises three air core inductors 75r, 75s and 75t, each connected to one phase of a three-phase supply 4, via respective input isolators 71r, 71s, 71t, and to a load 5 via respective output isolators 72r, 72s, 72t.

The inductors 75r, 75s and 75t are arranged such that their self-reactances are substantially equal to a first reactance value, and that the mutual reactances between each pair of inductors 75r, 75s and 75t is substantially equal to a second reactance value, with the second reactance value being substantially equal to the first reactance value.

In this embodiment, the inductors are formed out of HTS wire. In this embodiment, the normal operating current of the FCL 70 is well below the critical current that changes the superconductive wire into resistive state.

Furthermore, in this embodiment, the design of the FCL is such that in case of one phase to ground short-circuit as shown in FIG. 7 (e.g. for phase T) in point SC1, the FCL 70 will limit the fault current up to a predetermined value (which is also below the critical current) without the superconductive wire of that phase changing into resistive state.

In other words, in this embodiment, the critical current that causes the HTS wire to change into resistive state is more than the current limited by the inductors 75r, 75s and 75t in the event of a single phase fault. Hence, in a single phase fault, the HTS wire of any of the inductors 75r, 75s and 75t does not change into resistive state.

In case of two or three-phase short circuit (as shown in FIG. 7 as points SC2, SC3) the fault current will not be limited by the inductor 75r, 75s and 75t to the same degree as for a single phase fault. This will cause the inductors 75r, 75s and 75t to change to a resistive state, limiting the fault.

As an alternative to FIG. 7, in some embodiments, there is provided an FCL with three air core inductors (non HTS) each in series with a portion of HTS wire. In such embodiments, the HTS wire (which need not be coiled) would then act as a resistor only in the event of a two or three phase fault.

FIG. 8 shows an FCL 80 according to another embodiment of the invention. In this embodiment, the FCL 80 is shown schematically, and comprises three air core inductors 85r, 85s and 85t, each connected to one phase of a three-phase supply 4, via respective input isolators 81r, 81s, 81t, and to a load 5 via respective output isolators 82r, 82s, 82t.

In this case inductors 85r, 85s, 85t are performed using non superconductive wires/cables.

The FCL 80 further comprises a first additional current limiter 88 connected in series with the inductor 85r for the R phase, and a second additional current limiter 88 connected in series with the inductor 85s for the S phase. In this embodiment, no additional current limiter is provided for the T phase. In other embodiments, the first and second additional current limiters 88 could be on other combinations of the inductors.

The first additional current limiter and the second additional current limiter both comprise a very fast or explosive fast circuit breaker 88a and a fuse 88b connected in parallel.

The FCL 80 further comprises a controller 89 that controls the operation of the first and second very fast or explosive fast circuit breakers 88a. In addition, the controller 89 monitors the current on the inductors 85r, 85s and 85t.

In single phase fault conditions, the FCL 80 will limit the fault, in the way described above. Hence, in single phase fault conditions, the controller 89 does not activate the circuit breakers 88a.

In the event of a two phase fault, the controller 89 is arranged to activate one of the circuit breakers 88a. For example, in a two phase fault on the S and T phases (labelled as SC2 in FIG. 8), the controller 89 activates the circuit breaker 88a of the second additional current limiter 88. This causes the fuse 88b of the second additional current limiters 88 to blow, hence stopping the flow of current on the S phase. In this case, the fault on the T phase will be limited by the self-reactance X_{T} of the inductor 85t.

Hence, it will be appreciated that by providing additional current limiters in series with two out of the three inductors 85r, 85s and 85t, regardless of which two of the phases R, S or T are experiencing the two phase fault, the controller 89 can cause one circuit breaker 88a to activate, thus limiting the two phase fault.

In the event of a three phase fault, the controller 89 is arranged to activate both of the circuit breakers 88a. Hence, current will be stopped in two of the three inductors (it will be 85r and 85s in FIG. 8), and the current on the other inductor will be limited as a result of the self-reactance of that inductor.

Hence, the embodiment of FIG. 8 uses only two (as opposed to three) additional current limiting devices comprising circuit breakers. As a result, the number of additional current limiting devices comprising circuit breakers can be reduced.

It will be appreciated that the activation of the circuit breaker 88a and the blowing of fuse 88b will require the replacement of both the circuit breaker 88a (if it is of the explosive type) and the fuse 88b. The embodiment of FIG. 8 minimises the replacement of the circuit breaker 88a and fuse 88b, but not activating any circuit breakers 88a in the event of a single phase fault. Furthermore, in the event of a two phase fault only one circuit breaker 88a is activated and should be replaced.

Hence, this embodiment of the present invention limits for one, two and three phase faults using only two circuit breakers and associated fuses. Of course, in other embodiments, three additional current limiting devices could be provided.

FIG. 9 shows an FCL 90 according to another embodiment of the invention. In this embodiment, the FCL 90 is shown schematically, and comprises three air core inductors 95r, 95s and 95t, each connected to one phase of a three-phase supply 4, via respective input isolators 91r, 91s, 91t, and to a load 5 via respective output isolators 92r, 92s, 92t.

The FCL 90 further comprises a first additional current limiter 98 connected in series with the inductor 95r for the R phase, and a second additional current limiter 98 connected in series with the inductor 95s for the S phase. In this embodiment, no additional current limiter is provided for the T phase. In other embodiments, the first and second additional current limiters 98 could be on other combinations of the inductors.

Hence, in this embodiment, the first and second additional current limiters 98 act as resonant link devices.

The first additional current limiter 98 and the second additional current limiter both comprise an additional inductor 98a and a capacitor 98b connected in series, and a bypass thyristor 98c connected in parallel with the capacitor 98b. In normal and single-phase fault limited by inductors 95r (or 95s, or 95t) conditions, the voltage is not sufficient to trigger the bypass thyristor 98c, and the capacitor 9b is arranged to compensate for the reactance of the additional inductor 98a in normal conditions.

Due to resonance conditions between inductor 98a and capacitor 98b drop voltage on capacitor 98b will be proportional to the current. Thus self-trigger conditions may be provided for current slightly more than predetermined value of limited single-phase fault current. If the drop voltage across the capacitor exceeds this value, thyristors 98c will bypass the capacitor and the additional inductor 98a will provide current limitation.

Also provided in this embodiment in the first additional current limiter 98 is a metal-oxide arrester MOV, which functions to protect the capacitor in case when the thyristor 98c fails.

In this embodiment, the inductors 95r, 95s, 95t are calculated to limit fault current to no more than e.g. 5 kA. In the event of a single phase fault, the additional 98 resonant link will not be activated. In the event of a two phase fault, or 3 phase fault, FCL 90 initially provides no current limiting, and thus the current through the resonant links 98 will be higher than e.g. 5 kA. This will trigger either one or two resonant links and inductors 98a will provide current limiting. Inductors 98a are calculated to provide current limiting to levels which will cause the 3^{rd} phase (which does not have a resonant link in series) to activate the FCL 90 current limiting due to the asymmetry caused. Thus, the triggering criterion can be adjusted in accordance to a current higher than the FCL 90 maximum limited single phase fault current e.g. 5.5 kA. Thus for single phase fault current limited by coreless FCL 90—the electronic activation (thyristors and metal oxide arrester MOV) will be avoided.

In the event of a single phase fault, the three air core inductors 95r, 95s and 95t will limit the fault in the manner described above. Furthermore, a single phase fault on one of R, S or T lines that comprises either the first or second additional current limiter will not be enough to trigger the bypass thyristor 98c.

In the event of a two phase fault, one or two of the bypass thyristors 98c is arranged to close. This will cause the capacitor 98b of that additional current limiter 98 to be bypassed, and the additional inductor will act to limit the fault current. For example, a in the event of a two phase fault between the S and T lines (shown as SC2 in FIG. 9), the bypass thyristor 98c on the S line will activate, bypassing the capacitor 98b on the S line. In this case, there is no need for a fault condition discriminating mechanism beyond the self-triggered mechanism described above. Thus in case fault in R-T and S-T fault currents only one resonant link devices will be activated. However, in the case of an R-S fault both resonant link devices will be activated.

In the event of a three phase fault and R-S two phase fault, the bypass thyristors 98c of both the first and second additional current limiters 98 will activate, causing the additional inductors to limit the fault current on two of the three lines. The fault current on line T in FIG. 9 will be limited by the action of the inductors 95r, 95s and 95t.

Hence, this embodiment of the present invention limits for one, two and three phase faults using only two resonant link devices. Of course, in other embodiments, three resonant link devices could be provided.

In other embodiments, the bypass thyristor 98c could be replaced with another form of electronic switch, such as a GTO or other suitable device.

In any of the above mentioned embodiments, it will be appreciated that the inductors (e.g. those made from conventional wire/cables) could be cooled by various means. For example, cooling liquid (e.g. oil as for transformers) for providing cooling of inductors could be used.

As discussed above, embodiments of the invention provide a fault current limiter is provided for connection to a three phase AC supply. The fault current limiter comprises a first inductor for connection to a first phase of the AC supply; a second inductor for connection to a second phase of the AC supply; a third inductor for connection to a third phase of the AC supply. Each of the first, second and third inductors comprises a coil, and each of the coils of the first, second and third inductors is such that the self-reactance of each of the first, second and third inductors are substantially equal to a first reactance value. Furthermore, the coils of each of the first, second and third inductors are arranged such that the mutual reactance between each pair of inductors is substantially equal to a second reactance value, and the second reactance value is substantially equal to the first reactance value.

In such arrangements, the FCL is associated with a very low insertion impedance for symmetrical loads in normal conditions. This is due to the balancing of the self and mutual reactances of the inductors. Furthermore, in single phase fault conditions, the inductor connected to the phase at fault will act to limit the fault, due to the fault conditions removing the balance of the self and mutual reactances of the inductors.

In some embodiments, at least one of the first, second and third inductors is an air core inductor. For example, all of the first, second and third inductors may be air core inductors. In other embodiments, one or two of the first, second and third inductors may be air core inductors.

In some embodiments, at least one of the first, second and third inductors may comprise a permeable (e.g. ferromagnetic) core located inside and/or around its coil.

Many further variations and modifications will suggest themselves to those versed in the art upon making reference to the foregoing illustrative embodiments, which are given by way of example only, and which are not intended to limit the scope of the invention, that being determined by the appended claims.

1. A fault current limiter for connection to a three phase AC supply, the fault current limiter comprising:
a first air core inductor for connection to a first phase of the AC supply;
a second air core inductor for connection to a second phase of the AC supply;
a third air core inductor for connection to a third phase of the AC supply;
wherein each of the first, second and third inductors comprises a coil;
wherein each of the coils of the first, second and third inductors is such that the self-reactance of each of the first, second and third inductors are substantially equal to a first reactance value;
wherein the coils of each of the first, second and third inductors are arranged such that the mutual reactance between each pair of inductors is substantially equal to a second reactance value, and wherein the second reactance value is substantially equal to the first reactance value.

2. A fault current limiter according to claim 1, wherein the second reactance value is greater or equal to 85% of the first reactance value, optionally wherein the second reactance value is greater or equal to 90% of the first reactance value.

3. A fault current limiter according to claim 1, wherein the self-reactances of each of the first, second and third inductors are within 10% of each other, optionally wherein the self-reactances of each of the first, second and third inductors are within 5% of each other.

4. A fault current limiter according to claim 1, wherein the mutual reactances between each pair of inductors are within 10% of each other.

5. A fault current limiter according to claim 1, wherein a coil geometry of each of the coils of the first, second and third inductors is the same.

6. A fault current limiter according to claim 1, wherein a number of turns of each of the coils of the first, second and third inductors is the same.

7. A fault current limiter according to claim 1, wherein the first, second and third inductors have a different number of turns so as to compensate for a difference coil geometry of each of the coils of the first, second and third inductors is the same.

8. A fault current limiter according to claim 1, wherein each of the coils of the first, second and third inductors comprises a same material.

9. A fault current limiter according to claim 1, wherein the coil of each inductor is wound around a parallel axis.

10. A fault current limiter according to claim 1, wherein the coils of each inductor are wound around a common axis.

11. A fault current limiter according to claim 1, further comprising a first input termination for the first inductor, a second input termination for the second inductor, and a third input termination for the third inductor, wherein the first, second and third input terminations are for connecting the first, second and third inductors in series with power carrying conductors connected to the three phase AC supply.

12. A fault current limiter according to claim 1, further comprising a first output termination for the first inductor, a second output termination for the second inductor, and a third output termination for the third inductor, wherein the first, second and third output terminations are for connecting the first, second and third inductors in series with power carrying conductors connected to a load.

13. A fault current limiter according to claim 1, wherein the first, second and third inductors comprise superconductive material.

14. A fault current limiter according to claim 13, wherein a critical current to transition the superconductive material from a superconductive state to a resistive state is more than a current limited by the first, second and third inductors in the event of a single phase fault.

15. A fault current limiter according to claim 14, wherein the critical current to transition the superconductive material from the superconductive state to the resistive state is less than a current limited by the first, second and third inductors in the event of a three phase fault.

16. A fault current limiter according to claim 14, wherein the critical current to transition the superconductive material from the superconductive state to the resistive state is less than a current limited by the first, second and third inductors in the event of a two phase fault.

17. A fault current limiter according to claim 1, wherein the first, second and third inductors are comprised in a common three-core cable, wherein the common three-core cable is wound in a coil.

18. A fault current limiter according to claim 1, wherein the first, second and third inductors each inductor comprise a flat spiral coil, wherein the flat spiral coils of the first, second and third inductors are arranged in a stack of three flat spiral coils.

19. A fault current limiter according to claim 18, wherein the three phase fault current limiter comprises a plurality of said stacks of three flat spiral coils.

20. A fault current limiter according to claim 19, wherein a spacing of adjacent stacks is equal to the spacing of each of the flat spiral coils within each stack.

21. A fault current limiter according to claim 1, wherein the coil of the second inductor is wound around the coil of the first inductor, and the coil of the third inductor is wound around the coil of the second inductor.

22. A fault current limiter according to claim 1, further comprising:
at least one additional current limiter, each additional current limiter comprising a portion of HTS wire connected in series with a respective one of the first inductor, second inductor or third inductor;
wherein the at least one additional current limiter is arranged to transition from a superconductive state to a resistive state in the event of a fault on the AC supply that it is connected to.

23. A fault current limiter according to claim 1, further comprising:
a first additional current limiter connected in series with the first inductor, the first additional current limiter comprising a first circuit breaker and a first fuse connected in parallel;
a second additional current limiter connected in series with the second inductor, the second additional current limiter comprising a second circuit breaker and a second fuse connected in parallel;
a controller for controlling the operation of the first and second circuit breakers, and for monitoring current on the first, second and third inductors, wherein the controller is arranged to activate only the first circuit breaker in the event of a two phase fault and to activate both the first circuit breaker and the second circuit breaker in the event of a three phase fault.

24. A fault current limiter according to claim 1, further comprising:
a first additional current limiter connected in series with the first inductor, the first additional current limiter comprising a first additional inductor and a first capacitor connected in series, the first capacitor arranged to compensate for the reactance of the first additional inductor in normal conditions, the first additional current limiter further comprising a first bypass electronic switch connected in parallel with the first capacitor;
a second additional current limiter connected in series with the second inductor, the second additional current limiter comprising a second additional inductor and a second capacitor connected in series, the second capacitor arranged to compensate for the reactance of the second additional inductor in normal conditions, the second additional current limiter further comprising a second bypass thyristor connected in parallel with the second capacitor;
wherein in the event of a two phase fault, one of the first or second bypass thyristors is arranged to close, so as to bypass the respective one of the first or second capacitors;
wherein in the event of a three phase fault, both of the first and second bypass thyristors are arranged to close, so as to bypass both of the first and second capacitors.

25. A fault current limiter according to claim 1, wherein at least one of the first, second and third inductors comprises a permeable core inserted inside and/or around its coil.
